(19) United States
(12) Patent Application Publication
(10) Pub. No.: US 2017/0302010 A1
(43) Pub. Date: Oct. 19, 2017

(54) SHIELD WIRE

(71) Applicant: TATSUTA ELECTRIC WIRE & CABLE CO., LTD., Osaka (JP)

(72) Inventors: Kiyotaka URASHITA, Kyoto (JP); Yoshinori KAWAKAMI, Osaka (JP)

(21) Appl. No.: 15/516,062

(22) PCT Filed: Sep. 29, 2015
(86) PCT No.: PCT/JP2015/077518

§ 371 Date: Mar. 31, 2017

(30) Foreign Application Priority Data
Oct. 3, 2014 (JP) 2014-204965

(51) Int. Cl. H01R 9/03; H01R 13/6581; H01B 11/10; H01R 43/28

(52) U.S. Cl. CPC H01R 9/032; H01R 43/28; H01B 11/1008; H01B 11/1091; H01R 13/6581

(57) ABSTRACT

A shield wire (P) that facilitates terminal processing is provided. This shield wire (P) includes a plurality of core wires and an inclusion (2) twisted together to form a core (3) having a cross-sectional circular shape, a drain wire (4) laterally wound around an outer periphery of the core, a shield tape (5) wound around, and a sheath (6) further disposed outside the shield tape (5). The shield tape (5) includes metal thin films (5b and 5c) on surfaces of a resin film (5a). An adhesive layer (7) is interposed between the shield tape and the sheath. The shield tape is adhesively integrated with the sheath by the adhesive layer.

### TECHNICAL FIELD

The present invention relates to a shield wire having a shield layer (a shielding layer) against electromagnetic wave and a method for manufacturing the shield wire.

### BACKGROUND ART

As a shield wire, a shielded twisted pair cable (a wire) is known. This shield wire includes a conductive foil, such as an aluminum foil, which covers an outer periphery of a core including two insulated core wires twisted with one another and a drain wire. This shield wire includes the conductive foil and an external insulator (a sheath) that are adhered to one another with an adhesive.

It is disclosed that when stripping the external insulator of this shielded twisted pair cable, the conductive foil can be stripped together with an external insulating layer (see paragraph 0018 in the following PATENT LITERATURE 1).

### CITATION LIST

### Patent Literature

PATENT LITERATURE 1: JP-A-2008-287948
PATENT LITERATURE 2: JP-UM-A-5-38719

### SUMMARY OF THE INVENTION

### Problems to be Solved by the Invention

However, the shielded twisted pair cable includes a core including twisted insulated core wires. A cross-sectional surface of the twisted insulated core wires has recessed space portions. Therefore (see FIGS. 1 and 2 in PATENT LITERATURE 1), an outer surface of the core is uneven due to the recessed space portions. In view of this, in extrusion molding of the external insulator, a force to press the conductive foil from a core side to the external insulator (a reactive force against the extrusion molding force (molding pressure)) is not applied over a whole region of the outer surface. Instead, this reactive force possibly acts only on extruding portions partially. As a result, since the pressing force is poor, there may be portions without adhesion between the conductive foil and the external insulator. Therefore, when the external insulator is stripped, there is a case where the conductive foil cannot be stripped together with the external insulating layer.

Under the above-mentioned actual situation, an object of the present invention is to ensure stripping a shield layer, such as a metal foil, together with the external insulator when the external insulator (the sheath) is stripped in a shield wire including the shield layer made of a metal thin film, such as the metal foil.

### Solution to the Problems

To achieve the above-described object, first, in the present invention, across-sectional surface of a core is formed so as to be a circular shape (circular) by a plurality of core wires (including both a single (one) wire and a plurality of twisted wires of the single wire) and an inclusion being twisted together.

Since the inclusion enters between each of the core wires, the cross-sectional surface of the core including the inclusion is easily formed into the circular shape (an outer surface of the core is less likely to be uneven). Furthermore, most of this surface is occupied by the inclusion. In view of this, a shield layer made of a metal thin film, such as a metal foil, easily slips with respect to the surface of the core. Therefore, stripping of a sheath is smooth.

Next, forming the core by simply twisting the core wires and the inclusion, and a drain wire does not possibly expose the drain wire on the surface of the core. In such a case, the drain wire does not contact the shield layer. Consequently, earth (grounding) by the drain wire fails. Therefore, the drain wire laterally wound around an outer periphery of the core after the core wires and the inclusion are twisted together is disposed. This inevitably exposes the drain wire on the surface of the core and certainly brings the drain wire in contact with the shield layer. Then, the earth by the drain wire is certainly performed.

Furthermore, with the present invention, the shield layer includes the metal thin film formed on a surface of a resin film. Then, this resin film attached with the metal thin film is wound around the outer periphery of the core with the drain wire interposed to form the shield layer.

The resin film has a tensile strength compared with the metal foil. Therefore, a shield tape made of this resin film is wound around the core having a cross-sectional circular shape including the above-described core wires and inclusion twisted with one another. This ensures causing the shield tape to serve as a tape.

With the present invention, the shield layer and the sheath are adhered to one another with an adhesive layer interposed therebetween as is conventionally done.

The cross-sectional surface of the core with the circular shape as described above provides pressing force acting from a core side to an outer periphery of the shield layer over the whole surface. In view of this, in an extruding process of the sheath, the pressing force acts between both sides over the whole circumference surfaces on the adhesive layer between the shield layer and the sheath. Therefore, the shield layer and the sheath are certainly adhered over these whole circumference surfaces to be integrated. In view of this, there is no portion partially without adhesion between the shield layer and the sheath. Therefore, in this shield wire, it is difficult to generate a failure such as a generation of a fatigue crack due to a locally significant distortion caused by the portion without adhesion when repeated bending actions are applied. Therefore, a bending resistance of this shield wire is less likely to deteriorate.

As described above, most of the surface of the core is occupied by the inclusion. Therefore, a sticking force between the core and the shield layer lowers. In view of this, the shield layer is easily stripped together with stripping of the sheath.

Thus, once the shield layer is stripped, the entire shield layer in a terminal portion corresponding to the stripped sheath is taken away. Therefore, grounding (earth) is no longer possible. In view of this, with the present invention, the drain wire that is laterally wound around the core is disposed. If the drain wire is not cut in the stripping work of the sheath (if the following nick t is not made on a drain wire 4), the drain wire may exist the terminal after stripping the sheath and the shield layer. That is, in this configuration, stripping the sheath may also remove the shield layer. Therefore, the drain wire is disposed on the surface of the core including the core wires and the inclusion twisted with one another.

This inevitably exposes the drain wire on the surface of the core. Therefore, the drain wire is certainly brought into contact with the shield layer.

As a configuration of the present invention, the shield wire can employ the following configuration. According to this configuration, the core having the cross-sectional circular shape is formed by twisting the core wires and the inclusion. Then, the drain wire is laterally wound around the outer periphery of this core over the whole length. The shield layer is formed on this outer periphery. Furthermore, the sheath is disposed outside this shield layer. The shield layer is formed by winding the shield tape including the metal thin film formed on the surface of the resin film around the outer peripheral surface of the core to have the drain wire interposed. The adhesive layer is interposed between this shield tape and the sheath. The shield tape is adhesively integrated with the sheath by the adhesive layer. The shield layer (the shield tape) is stripped together the sheath when this sheath is stripped.

In this configuration, a filling rate of the above-described inclusion between the above-described core wires may be 1.0 or more. When the filling rate is less than 1.0, the outer surface of the core is likely to be uneven. Therefore, the pressing force that presses the shield layer against the sheath from the core side is not applied over the whole region of this outer surface in the extrusion molding of the sheath. Instead, this pressing force may act only on extruding portions partially. As a result, there are portions without adhesion in a wide range between the shield layer and the sheath since the pressing force is poor. Therefore, there is a case where the sheath cannot be stripped together with the shield layer when the sheath is stripped.

The filling rate means a value obtained by dividing an amount of the inclusion inserted between the core wires by a space cross-sectional area in the cross-sectional surface of the above-described shield wire. This space cross-sectional area is, for example, areas obtained by geometrically calculating an area s (dark shaded area) in FIGS. 5(a) to (e). As illustrated in these drawings, the area s is an area surrounded by circumscribed circles c₁ and a circumscribed circle c₂. The circumscribed circles c₁ are circumscribed circles of the plurality of paired twisted wires (the core wire including two insulating coated conductors twisted with one another and denoted with a reference numeral 1′ in the drawings). The circumscribed circle c₂ is a circumscribed circle of the twisted wire including the plurality of the core wires (the paired twisted wires 1′), which are twisted together. In the case where the core wire is one, the circumscribed circle c₁ is an outer peripheral circle of the one core wire. In claims in CLAIMS, the circumscribed circle is inclusively referred to as an outer peripheral circle. The amount of the inclusion means a value obtained by summing the cross-sectional area of all the inclusion inserted between the core wires.

In the drawings, FIG. 5(a) illustrates the case of two core wires. FIG. 5(b) illustrates the case of three core wires, FIG. 5(c) illustrates the case of four core wires, FIG. 5(d) illustrates the case of five core wires, and FIG. 5(e) illustrates the case of seven core wires. Setting a diameter of the paired twisted wire 1′ (a diameter of the circumscribed circle C₁) to d, in the case of the two core wires, an area s₁ surrounded by the circumscribed circle c₁ of the two paired twisted wires 1′ and the circumscribed circle c₂ of the twisted wire is 0.7854d². This space cross-sectional area s is 2s₁ (s=2s₁). In the case of the three core wires, the area s₁ is 0.4167d. The space cross-sectional area s is s=3s₁. In the case of the four core wires, the area s₁ is 0.306d. The space cross-sectional area s is s=4s₁. In the case of the five core wires, the area s₁ is 0.252d². The space cross-sectional area s is s=5s₁. In the case of the seven core wires, the area s₁ is 0.2215d². The space cross-sectional area s is s=6s₁.

In the event that the adhesive layer is made of thermoplastic adhesive resin, the sheath is usually formed by extrusion molding of the resin. Therefore, heat of the resin in this extrusion molding melts the adhesive resin so both resins may be firmly connected. As a result, this improves connection strength of the shield layer and the sheath with the adhesive layer interposed therebetween. This facilitates to improve the bending resistance of the shield wire and reduce the deterioration of the shield property due to the bending action.

In the above-described configuration, the above-described shield tape may include a plurality of nicks extending in a direction intersecting with a longitudinal direction of the wire. The nicks can be formed over a whole length in the longitudinal direction of the wire.

This configuration facilitates the bending via the nicks. Therefore, flexibility of the shield tape wound around improves. in the terminal processing of this shield wire, the shield tape (the shield layer) of the terminal is torn and stripped with the sheath via the nick of this shield tape irrespective of whether the nick made on the sheath reaches the shield layer or not when the terminal sheath is stripped from the nick made on the outer peripheral surface of the sheath having a necessary length of this terminal. This is because the shield tape forming the shield layer is adhered to the sheath to cause strip force of the sheath to apply to the shield tape.

The shield wire having these configurations can be manufactured by various conventional methods for manufacturing. For example, this method for manufacturing man employ the following configuration. First, the core is formed by twisting the core wires and the inclusion. While this core travels in a longitudinal direction of the core, the drain wire is laterally wound around the outer periphery of the core. Thereafter, the above-described shield tape is wound around as a winding tape. The adhesive layer is formed by extruding the thermoplastic adhesive resin on an outer peripheral surface of this shield tape. Furthermore, the sheath is disposed outside the adhesive layer by the extrusion molding.

According to the method for manufacturing having this configuration, the resin for the sheath in a high temperature in the extrusion molding and the adhesive resin melted by the heat in this extrusion molding are firmly connected. Therefore, it is less likely to generate the portion without adhesion between the sheath and the shield layer.

As the conductor of the core wire and the drain wire described above, well-known annealed copper twisted wires, annealed copper single wires or the like can be employed. For example, twisted wires or a single wire of copper alloy with the following configuration excellent in the bending resistance can maintain an effective electromagnetic shield property over a long period of time even when repeatedly receiving the bending action.

The Component of Copper Alloy is as follows:

“Zr: 0.01 to 0.05 weight %, Cr: 0.01 to 0.05 weight %, or 0.002 to 0.3 weight % in a total amount of one or more of In, Sn, Ag, Al, Bi, Ca, Fe, Ge, Hf, Mg, Mn, Ni, Pb, Sb, Si, Ti, Zn, B, Y and O may be added to them, and the rest part of the whole is substantially formed of Cu (see claim 2 in PATENT LITERATURE 2).”

### EFFECTS OF THE INVENTION

The present invention is configured as described above to be excellent in the bending resistance and the electromagnetic shield property. Therefore, the shield wire of the present invention is usable as a shield wire that ensures facilitating the terminal processing.

### BRIEF DESCRIPTION OF THE DRAWINGS

FIG. 1 is a cross-sectional view of one embodiment of a shield wire according to the present invention.

FIG. 2 is a front view of a main part partially cut of the embodiment.

FIGS. 3(a) and 3(b) are cross-sectional views of respective examples of shield tapes of the embodiment.

FIG. 4 is a perspective view for describing terminal processing of the embodiment.

FIGS. 5(a) to 5(e) are explanatory views of cross-sectional areas of spaces in a shield wire according to the present invention.

### DESCRIPTION OF THE EMBODIMENTS

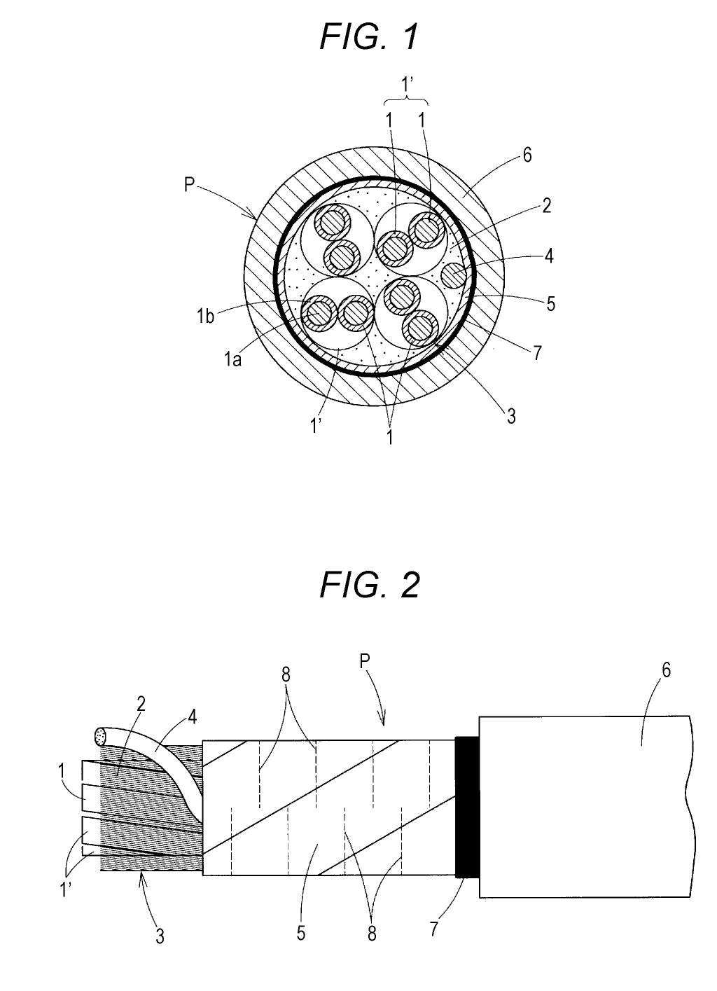

FIGS. 1 and 2 illustrate one embodiment of a shield wire P according to the present invention. This shield wire P is for a robot cable. This shield wire P includes four paired twisted wires 1′ (this paired twisted wire 1′ is also a core wire referred in each claims in CLAIMS), an inclusion 2 between these respective paired twisted wires 1′, a core 3, a drain wire 4, a shield tape 5 forming a shield layer, an adhesive layer 7, and a sheath (a protecting layer) 6. The paired twisted wires and the inclusion 2 are twisted together and included in the core 3. The drain wire 4 is laterally wound around an outer peripheral surface of this core 3 over a whole length of the core 3. The shield tape 5 is laterally wound around a whole circumference of this core 3 to have the drain wire 4 interposed. The sheath (the protecting layer) 6 is disposed on this shield tape (the shield layer) 5. The adhesive layer 7 is disposed between this shield tape 5 and the sheath 6.

The paired twisted wire 1′ is constituted of two core wires 1 and 1 twisted with one another. The twisted pitch can be set appropriately according to a usage configuration. The core wire 1 constituting the paired twisted wire 1′ includes a copper alloy twisted wire 1a whose cross-sectional area is 0.2 mm² and an insulating coating 1b, which is polyvinyl chloride or the like, disposed on the copper alloy twisted wire 1a. The number, diameter, and the like of these core wires 1 and the paired twisted wires 1′ can be set appropriately according to a usage aspect. In this embodiment, the core wire 1 includes the insulating coating 1b made of polyvinyl chloride. These insulating coatings 1b have different colors, such as of red, green, black, and white, as necessary. This ensures identification of the insulating coatings 1b.

As the conductor 1a of the core wire 1, other than copper alloy, a well-known material, such as tin-plated annealed copper, aluminum, and aluminum alloy, can be appropriately employed. As the insulating coating 1b, other than polyvinyl chloride, a well-known material, such as polyethylene, cross-linked polyethylene, polypropylene, and fluororesin, can be appropriately employed.

The inclusion 2 is constituted of a staple yarn and the like. The inclusion 2 is used for roundly finishing the core 1′ when twisting the respective paired twisted wires 1′ (the core wires 1). Other than the staple yarn, a well-known material, such as a PPC yarn, a paper tape, a paper yarn, a jute yarn, a kynol yarn, a cotton yarn, a polyvinyl chloride (PVC) yarn, and a polyethylene (PE) yarn, can be appropriately employed. In this embodiment, the staple yarn is used.

The core 3 of this shield wire P is made by the paired twisted wires twisted with one another to have this inclusion 2 interposed. Therefore, as illustrated in FIG. 1, the core 3 has a cross-sectionally circle. The core 3 has a cross-sectional circular shape. Most of the outer peripheral surface of the core 3 having the cross-sectional circular shape is occupied by the inclusion 2 made of the staple yarn. The staple yarnhas a high release property. Therefore, a surface of the core 3 has the high release property from the shield layer.

A filling rate of the inclusion 2 inserted in a space (the above-described cross-sectional area of spaces of the above-described paired twisted wires 1′ is set to be 1.0 or more.

The drain wire 4 is constituted of a copper alloy twisted wire whose cross-sectional area is 0.2 mm². The drain wire 4 is vertically attached or laterally wound. In this embodiment, one drain wire is laterally wound. The number of the drain wire 4 can be arbitrarily set.

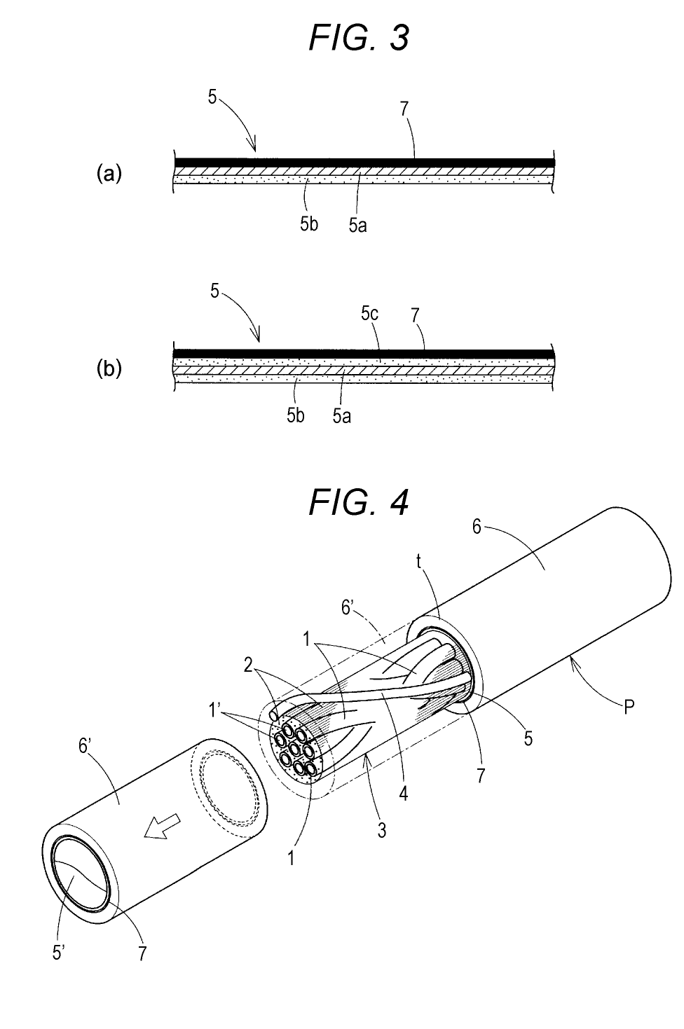

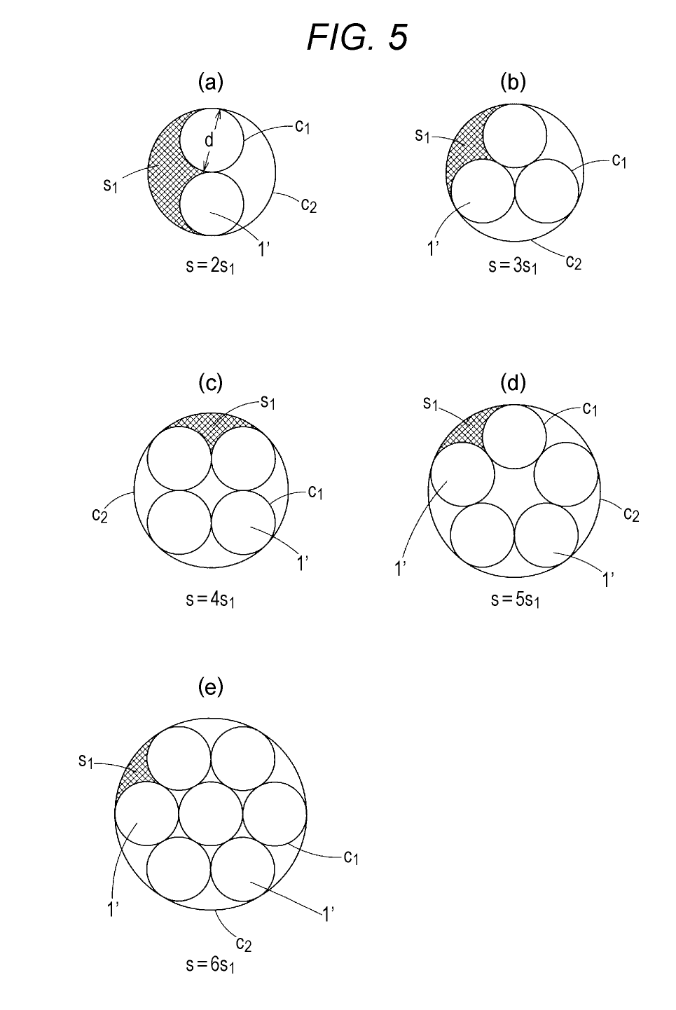

The shield tape 5 serves as a tape that maintains the cross-sectional circular shape of this core 3 by being wound around to have the drain wire 4 interposed, which is wound around the outer peripheral surface of the core 3. As illustrated in FIG. 3(a), the shield tape 5 may include a metal thin film 5b formed on one surface of a resin film 5a. As illustrated in FIG. 3(b), the shield tape 5 may include the metal thin film 5b and a metal thin film 5c formed on two surfaces of the resin film 5a. The shield tape 5 with the metal thin film 5b formed only on one surface has this metal thin film 5b surface facing a core 3 side.

Examples of the resin film 5a, which is used, includes a conventionally used resin, such as polyester, polyolefin, polyphenylene sulfide, polyamide, polyester amide, polyether, polystyrene, polyvinyl chloride, and polyethylene terephthalate (PET). In this embodiment, a PET film having a thickness of 12 μm is used. In the case where the metal thin films 5b and 5c are formed on two respective surfaces of the resin film 5a, the metal thin films 5b and 5c may employ mutually different materials. The metal thin films 5b and 5c may have mutually different surface roughnesses. The metal thin films 5b or 5c on a sheath 6 side can obtain an creased adhesive strength to the sheath 6 when the metal thin films 5b or 5c on the sheath 6 side have rougher surfaces.

As a forming means of the metal thin films 5b and 5c, conventionally used deposition, sputtering, foiling, and the like of a metal, such as aluminum, copper, argentum, gold, and nickel, can be employed. In this embodiment, as illustrated in FIG. 3(b), the aluminum deposition layers 5b and 5c having a thickness of 0.1 μm are employed.

The sheath 6 is made of a well-known resin, such as polyvinyl chloride, polyethylene, polyurethane, or polyester. In this embodiment, the polyvinyl chloride is employed.

As the adhesive layer 7, a material having h adhesive property to the resin film 5a or the metal thin film 5c, and the sheath 6 is appropriately employed. In this embodiment, polyester-based thermoplastic adhesive resin is used.

The adhesive layer 7 may be formed of thermoplastic adhesive resin of polystyrene-based, vinyl acetate-based, polyethylene-based, polypropylene-based, polyamide-based, rubber-based, acrylic-based, or the like. Add-in material such as metal powders, carbon black, filler, or stiffener may be added to the adhesive layer 7. However, if these add-in materials are added more than a specific amount, the add-in materials may easily expose from a surface of the adhesive layer so that the satisfactory adhesive property to the sheath 6 may not be guaranteed. Therefore, when adding these add-in materials, amounts of these add-in materials are appropriately chosen considering the adhesive property.

This adhesive layer 7 may be formed on a surface of the resin film 5a or the metal thin film 5c (may be the shield tape 5 attached with the adhesive layer 7) before the shield tape 5 is wound around the core 3. However, as described later, an adhesive layer can be formed after the shield tape 5 is wound around.

The shield wire P in this embodiment has the above-mentioned configuration. For manufacturing the shield wire P, first, a supply drum for the paired twisted wire 1′ constituted of the core wires 1 and a supply bobbin for the inclusion 2 are installed to a twisting machine. Then, each are brought out and pass through a predetermined position in a wide hole of a panel strip of the twisting machine. After completion of preparation, the twisting machine is driven and the core 3 having the cross-sectional circular shape is formed by twisting the paired twisted wires 1′ and the inclusion 2 together. Next, the drain wire 4 is laterally wound around the outer periphery of this core 3. Furthermore, the shield tape 5 is laterally wound around this outer peripheral surface. Thus, the shield layer is formed.

Next, the adhesive resin is extruded by an extruder to a whole surface of the outer periphery of the core 3 around which this shield tape 5 is wound. Thus, the adhesive layer 7 is formed on the outer peripheral surface of the core 3 to have a winding layer (the shield layer) of the shield tape 5 interposed.

The sheath 6 is disposed by further extruding and molding the resin by the extruder onto an outside of the adhesive layer 7 formed on the shield tape 5 wound (the shield layer formed) around the core 3. Thus, the shield wire P according to the present invention is manufactured. An extruding temperature of the above-described adhesive resin is 170° C. and a speed of the above-described adhesive resin is 20 m/s. An extruding temperature of the resin for the sheath is 170° C. and a speed of the resin for the sheath is 20 m/s.

Such fabricated shield wire P can be used as robot cable for communication, for electric power, or the like. Then, as illustrated in FIG. 1, most surface of the core 3 is occupied by the inclusion 2 made of the staple yarn. The core 3 is configured so as to easily move with respect to the shield tape 5 (the sheath 6). Therewith, a whole circumference surface of the shield tape 5 is integrated with the sheath 6 by being certainly adhered to the sheath 6. In view of this, with this shield wire P, the shield tape 5 (the sheath 6) easily moves with respect to the core 3 when repeatedly receiving the bending action in accordance with the movement of a robot. Therewith, a crack is less likely to occur in the shield layer constituted of the shield tape 5. Therefore, compared with a conventional similar type shield wire, flexibility and bending resistance of the shield wire P are excellent.

In terminal processing of this shield wire P, first, as illustrated in FIG. 4, a nick t is made over a whole circumference of the sheath 6 at a terminal portion having a necessary length by scissors or a stripper.

This nick t is also made at the shield layer (the shield tape 5) to the extent that the drain wire 4 is not cut (the nick t is not made at the drain wire 4). In this case, the core 3 is formed so as to have the cross-sectional circular shape. Therefore, the shield layer (the shield tape 5) of this terminal is certainly adhered to (integrated with) a whole surface of an inner periphery of the sheath 6 with the adhesive layer 7 formed on a whole surface of an outer periphery of this shield layer by the extrusion molding of the adhesive resin, in view of this, the nick t can be easily made at the shield layer (the shield tape 5), as well as the sheath 6.

Next, wider the state where the nick t is made, using the stripper or the like, the sheath 6′ of the terminal is moved as an arrow in the Figure. Then, the terminal sheath 6′ is stripped via this nick t.

In this stripping, since a shield tape 5′ of this terminal is adhered to (integrated with) the sheath 6′ with the adhesive layer 7, the shield tape 5′ is certainly stripped with this sheath 6′. Then, the core 3 is exposed (from a chain-line state to a solid-line state in FIG. 4).

Subsequently, tests were performed on strippabilities of the sheath 6 corresponding to amounts of the inclusion inserted between the paired twisted wires 1′ when the paired twisted wire 1′ has two core wires, four core wires, and five core wires.

First, shield wires having a strip length of approximately 300 m were fabricated by the above-described manufacturing method to be respective sizes of the wires for examples 1 to 3 and comparative examples 1 to 2 illustrated in Table 1. Next, one each of samples of approximately 20 cm was extracted at points of 50 m, 100 m, and 150 m from a start starting end). Thereafter, stripping tests of the sheath 6 were performed for three times in total.

As evaluation criteria, it was evaluated as “qualified” when the sheath 6 was stripped together with the shield layer (the shield tape 5) for all the three times when the sheath 6 is stripped with the nick t made on the sheath 6 by the above-described method. On the other hand, when the the sheath 6 was stripped without being together with the shield layer even once in the three times, it was evaluated as “disqualified.”

TABLE 1

| | | | | Outer diameter | | | |
|---|---|---|---|---|---|---|---|
| | | | | of core wire | | | |
| | Number | | | (outer diameter | | Outer | |
| | of paired | Outer | Outer | of circumscribed | Twisted | diameter | Outer |
| | twisted wires | diameter of | diameter of | circle of paired | outer | of shield | diameter |
| | Number | conductor | insulator | twisted wire) | diameter | layer | of sheath |
| | of wires | mm | mm | mm | mm | mm | mm |
| Example 1 | 2 | 0.5 | 1.08 | 1.84 | 4.0 | 4.6 | 6.6 |
| Example 2 | 4 | 0.5 | 1.08 | 1.84 | 4.7 | 5.3 | 7.3 |
| Example 3 | 5 | 0.5 | 1.08 | 1.84 | 5.3 | 5.9 | 7.9 |
| Comparative | 2 | 0.5 | 1.08 | 1.84 | 4.0 | 4.6 | 6.6 |
| example 1 | | | | | | | |
| Comparative | 4 | 0.5 | 1.08 | 1.84 | 4.7 | 5.3 | 7.3 |
| example 2 | | | | | | | |

| | Space area (s) | Inclusion (staple | | | |
|---|---|---|---|---|---|
| | surrounded by | yarn) inserted in | | | |
| | outer periphery | space of core wires | | | |
| | (c₁) of core wire | Cross-sectional | Total cross- | | |
| | and circumscribed | area (mm²) of | sectional area | | |
| | circle (c₂) of | staple yarn × | (filling amount) | | |
| | twisted wire | number of | of inclusion | Filling rate | Evaluation |
| | mm² | insertions | mm² | of inclusion | result |
| Example 1 | 5.34 | 0.07 × 87 | 6.09 | 1.14 | Qualified |
| Example 2 | 4.16 | 0.07 × 81 | 5.67 | 1.36 | Qualified |
| Example 3 | 4.28 | 0.07 × 94 | 6.58 | 1.54 | Qualified |
| Comparative | 5.34 | 0.07 × 44 | 3.08 | 0.58 | Disqualified |
| example 1 | | | | | |
| Comparative | 4.16 | 0.07 × 40 | 2.80 | 0.67 | Disqualified |
| example 2 | | | | | |

As shown in Table 1, the strippabilities of this sheath 6 were evaluated as qualified in the stripping tests when the filling rates of the inclusion 2 were 1.14, 1.36, and 1.54. When the filling rates were 0.58 and 0.67, the strippabilities were evaluated as disqualified. From this, it was shown that the shield layer (the shield tape 5) as well as the sheath 6 is stripped when the inclusion filling rate is 1.14 or more. Accordingly, it is estimated that the inclusion filling rate is preferred to be 1.0 or more.

As illustrated in FIG. 2, in the case where a plurality of nicks 8 extending in a direction intersecting with a longitudinal direction of the wire is formed on the shield tape 5 over a whole length of the shield tape 5 in the longitudinal direction, when the terminal sheath 6′ is stripped, the shield tape 5′ (the shield layer) of the terminal is torn off via the nicks 8 and stripped with the sheath 6′ irrespective of whether the nick t reaches the shield tape 5 or not. This is because the shield tape 5 is adhered to the sheath 6 to cause stripping force to be applied to the shield tape 5. Disposing this nick 8 improves the flexibility of the shield tape 5, which is wounded around.

The nick 8 may be in a perforation pattern. The nick 8 may be preliminarily formed on the resin film 5a. Alternatively, after the metal thin films 5b and 5c are formed, the nick 8 may be formed to reach these metal thin films 5b and 5c only or both the resin film 5a and the metal thin films 5b and 5c. At this time, the nick 8 may pass through the shield tape 5 or may be a half cut.

After stripping (removing) of the sheath 6′ and the shield tape 5′ of the terminal is finished, the drain wire 4 is removed from the core 3 as is conventionally done. Then, after operations, such as stripping the insulating coating 1b of the core wire 1, the core wire 1 and the drain wire 4 are coupled to terminals of various kinds of connector or electrical device.

For the conductor 1a of the core wire 1 and the drain wire 4 described above, an aggregated twisted wire or a single wire of the above-described copper alloy wire or the like can be employed.

It is obvious that the shield wire P according to the present invention can be used for not only the robot cable, but also various cables or the like that request the bending resistance.

The above-disclosed embodiment is all considered as illustrative and not restrictive. The scope of the invention is indicated by the appended claims. All variations and equivalents which fall within the range of the appended claims are intended to be embraced therein.

### LIST OF REFERENCE NUMERALS

P: Shield wire
t: Nick onto sheath and shield tape
1: Core wire
1′: Paired twisted wire
1a: Conductor of core wire
1b: Insulating coating of core wire
2: Inclusion
3: Core ade by twisting core wire (paired twisted wire) and inclusion
4: Drain wire
5: Shield tape (shield layer)
5′; Stripped terminal shield tape (shield layer
6: Sheath (protecting layer)
6′: Stripped terminal sheath
7: Adhesive layer
8: Nick of shield tape

1. A shield wire (P) comprising:
a plurality of core wires (1 and 1′) and an inclusion (2) twisted together to form a core (3) having a cross-sectional circular shape;
a drain wire (4) laterally wound around an outer periphery of the core (3) over a whole length of the core (3);
a shield layer formed on the outer periphery of the core (3); and
a sheath (6) further disposed outside the shield layer, wherein
the shield layer is formed by winding a shield tape (5) around the outer periphery of the core (3) to have the drain wire (4) interposed, the shield tape (5) including metal thin films (5b and 5c) formed on surfaces of a resin film (5a), an adhesive layer (7) is interposed between the shield tape (5) and the sheath (6),
the shield tape (5) is adhesively integrated with the sheath (6) by the adhesive layer (7),
the shield layer is stripped together with the sheath (6) when the sheath (6) is stripped, and
a filling rate of the inclusion (2) inserted in a space (s) surrounded by outer peripheral circles (c₁) of the respective core wires (1 and 1′) and a circumscribed circle (c₂) of the twisted wires is 1.0 or more.

2. (canceled)

3. The shield wire according to claim 1, wherein
a plurality of nicks (8) is formed on the shield tape (5) in a direction intersecting with a longitudinal direction of the wire (P) over the longitudinal direction.

4. The shield wire according to claim 1, wherein
the adhesive layer (7) is formed on a whole surface of an outer periphery of the shield layer by extrusion molding of a thermoplastic adhesive resin.

5. A method for manufacturing the shield wire (P) according to claim 4, comprising:
forming the core (3) by twisting the core wires (1 and 1′) and the inclusion (2);
laterally winding the drain wire (4) around the outer periphery of the core (3) while causing the core (3) to travel in a longitudinal direction of the core (3);
subsequently winding the shield tape (5) as a winding tape;
forming the adhesive layer (7) by extruding the thermoplastic adhesive resin on an outer peripheral surface of the shield tape (5); and
further disposing the sheath (6) outside the adhesive layer (7) by the extrusion molding.

6. The shield wire according to claim 3, wherein
the adhesive layer (7) is formed on a whole surface of an outer periphery of the shield layer by extrusion molding of a thermoplastic adhesive resin.
